(19) United States
(12) Patent Application Publication
(10) Pub. No.: US 2023/0186168 A1
(43) Pub. Date: Jun. 15, 2023

(54) PERFORMING AUTOMATED TUNING OF HYPERPARAMETERS IN A FEDERATED LEARNING ENVIRONMENT

(71) Applicant: International Business Machines Corporation, Armonk, NY (US)

(72) Inventors: Yi Zhou, San Jose, CA (US); Parikshit Ram, Atlanta, GA (US); Nathalie Baracaldo Angel, San Jose, CA (US); Theodoros Salonidis, Wayne, PA (US); Horst Cornelius Samulowitz, Armonk, NY (US); Martin Wistuba, Dublin (IE); Heiko H. Ludwig, San Francisco, CA (US)

(21) Appl. No.: 17/547,122

(22) Filed: Dec. 9, 2021

(51) Int. Cl. G06N 20/20

(52) U.S. Cl. CPC G06N 20/20

(57) ABSTRACT

A computer-implemented method according to one embodiment includes issuing a hyperparameter optimization (HPO) query to a plurality of computing devices; receiving HPO results from each of the plurality of computing devices; generating a unified performance metric surface utilizing the HPO results from each of the plurality of computing devices; and determining optimal global hyperparameters, utilizing the unified performance metric surface.

The following disclosure(s) are submitted under 35 U.S.C. 102(b)(1)(A): DISCLOSURE(S): [“FLoRA: Single-shot Hyper-parameter Optimization for Federated Learning,” Yi Zhou, Parikshit Ram, Theodoros Salonidis, Nathalie Bara-caldo, Horst Samulowitz and Heiko Ludwig, Dec. 1, 2021].

### BACKGROUND

The present invention relates to machine learning models, and more specifically, this invention relates to optimizing hyperparameters during a training of a machine learning model.

Machine learning is a popular means of decision making and is used in many different fields today. Federated learning is a popular means of training machine learning models that provides data privacy for collaborative training entities. However, hyperparameters used within local and global models during the implementation of federated learning are currently manually assigned, and often require many manual iterations to fine-tune. There is therefore a need to dynamically implement hyperparameters for models used within a federated learning environment.

### BRIEF SUMMARY

A computer-implemented method according to one embodiment includes issuing a hyperparameter optimization (HPO) query to a plurality of computing devices; receiving HPO results from each of the plurality of computing devices; generating a unified performance metric surface utilizing the HPO results from each of the plurality of computing devices; and determining optimal global hyperparameters, utilizing the unified performance metric surface.

According to another embodiment, a computer program product includes one or more computer readable storage media, and program instructions collectively stored on the one or more computer readable storage media, the program instructions including instructions configured to cause one or more processors to perform a method including issuing, by the one or more processors, a hyperparameter optimization (HPO) query to a plurality of computing devices; receiving, by the one or more processors, HPO results from each of the plurality of computing devices; generating, by the one or more processors, a unified performance metric surface utilizing the HPO results from each of the plurality of computing devices; and determining, by the one or more processors, optimal global hyperparameters, utilizing the unified performance metric surface.

According to another embodiment, a computer-implemented method includes receiving, from an aggregator, a hyperparameter optimization (HPO) query; performing HPO operations in response to receiving the query; sending local results of performing the HPO operations to the aggregator; generating a local performance metric surface utilizing local results of the HPO operations; receiving, from the aggregator, optimal global hyperparameters; and determining optimal local hyperparameters, utilizing the local performance metric surface and the optimal global hyperparameters.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one aspect of the present invention.

FIG. 2 depicts abstraction model layers in accordance with one aspect of the present invention.

FIG. 3 depicts a cloud computing node in accordance with one aspect of the present invention.

FIG. 4 illustrates a tiered data storage system in accordance with one aspect of the present invention.

FIG. 5 illustrates a flowchart of a method for performing automated hyperparameter tuning at an aggregator, in accordance with one aspect of the present invention.

FIG. 6 illustrates a flowchart of a method for performing automated hyperparameter tuning at a party, in accordance with one aspect of the present invention.

FIG. 7 illustrates an exemplary federated learning environment, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several aspects of performing automated tuning of hyperparameters in a federated learning environment.

In one general embodiment, a computer-implemented method includes issuing a hyperparameter optimization (HPO) query to a plurality of computing devices; receiving HPO results from each of the plurality of computing devices; generating a unified performance metric surface utilizing the HPO results from each of the plurality of computing devices; and determining optimal global hyperparameters, utilizing the unified performance metric surface.

In another general embodiment, a computer program product includes one or more computer readable storage media, and program instructions collectively stored on the one or more computer readable storage media, the program instructions including instructions configured to cause one or more processors to perform a method including issuing, by the one or more processors, a hyperparameter optimization (HPO) query to a plurality of computing devices; receiving, by the one or more processors, HPO results from each of the plurality of computing devices; generating, by the one or more processors, a unified performance metric surface utilizing the HPO results from each of the plurality of computing devices; and determining, by the one or more processors, optimal global hyperparameters, utilizing the unified performance metric surface.

In another general embodiment, a computer-implemented method includes receiving, from an aggregator, a hyperparameter optimization (HPO) query; performing HPO operations in response to receiving the query; sending local results of performing the HPO operations to the aggregator; generating a local performance metric surface utilizing local results of the HPO operations; receiving, from the aggregator, optimal global hyperparameters; and determining optimal local hyperparameters, utilizing the local performance metric surface and the optimal global hyperparameters.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

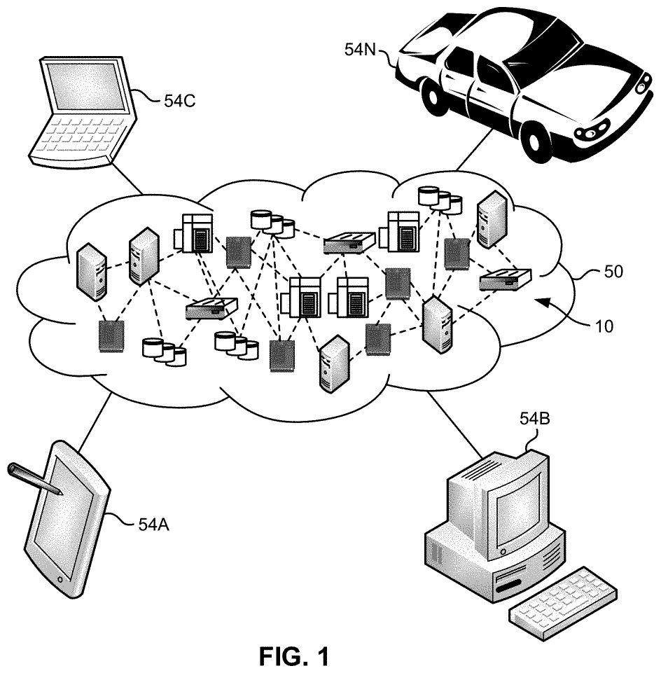

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

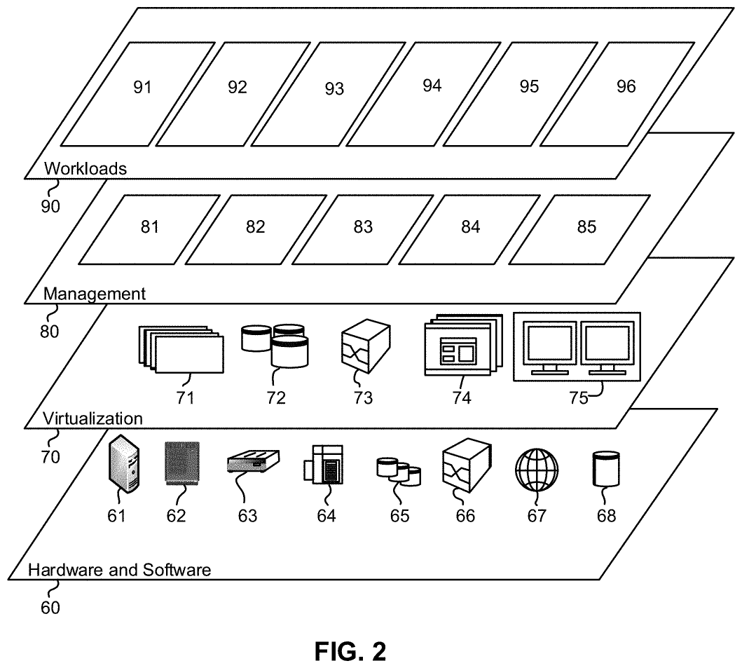

Referring now to FIG. 2, a set of functional abstraction layers provided by cloud computing environment 50 (FIG. 1) is shown. It should be understood in advance that the components, layers, and functions shown in FIG. 2 are intended to be illustrative only and aspects of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some aspects, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and federated learning 96.

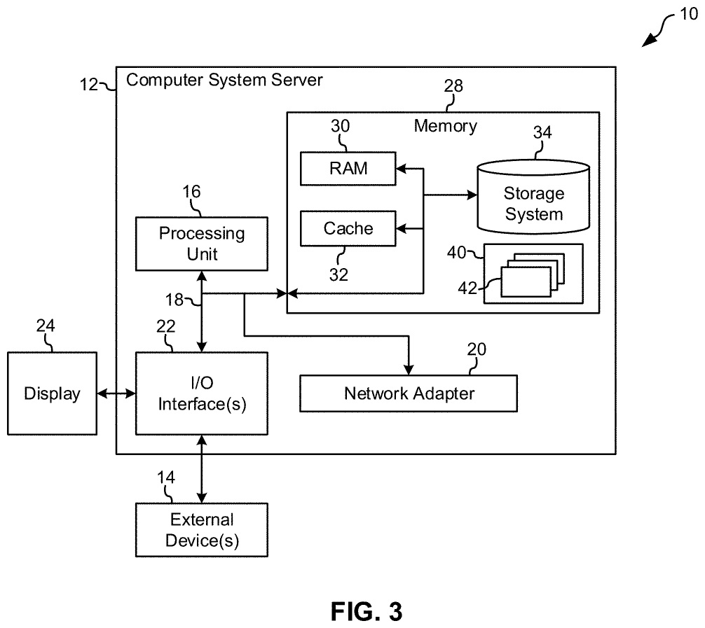

Referring now to FIG. 3, a schematic of an example of a cloud computing node is shown. Cloud computing node 10 is only one example of a suitable cloud computing node and is not intended to suggest any limitation as to the scope of use or functionality of aspects of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of aspects of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of aspects of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

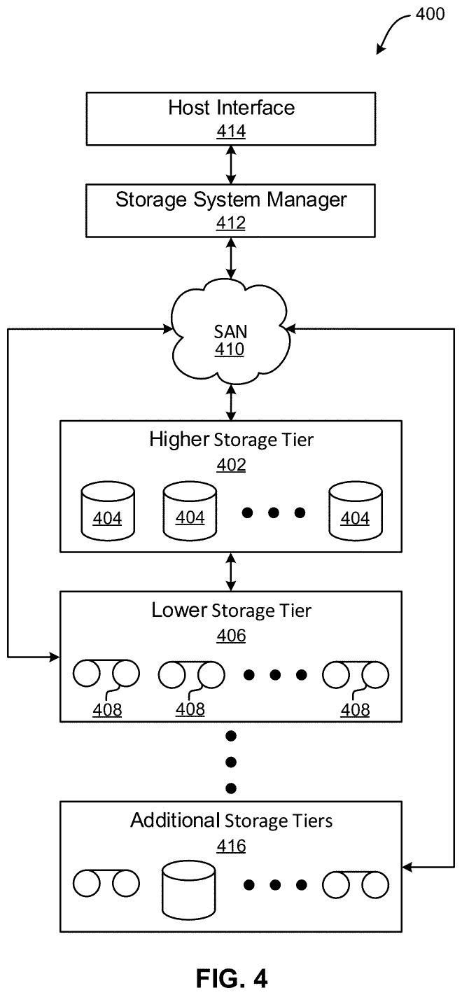

Now referring to FIG. 4, a storage system 400 is shown according to one aspect. Note that some of the elements shown in FIG. 4 may be implemented as hardware and/or software, according to various aspects. The storage system 400 may include a storage system manager 412 for communicating with a plurality of media on at least one higher storage tier 402 and at least one lower storage tier 406. The higher storage tier(s) 402 preferably may include one or more random access and/or direct access media 404, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 406 may preferably include one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Also, any of the higher storage tiers 402 and/or the lower storage tiers 406 may include some combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more aspects, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the aspects presented herein.

According to some aspects, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

Of course, this logic may be implemented as a method on any device and/or system or as a computer program product, according to various aspects.

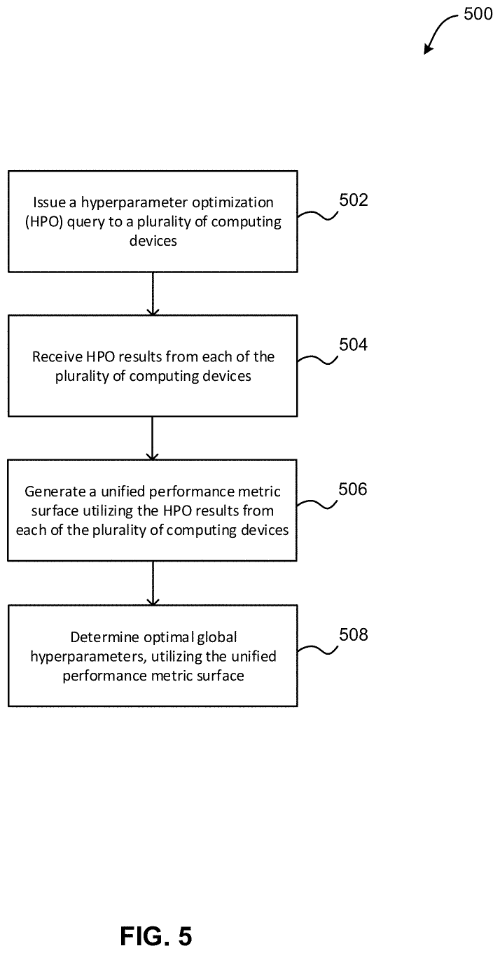

Now referring to FIG. 5, a flowchart of a method 500 is shown according to one embodiment. The method 500 may be performed in accordance with the present invention in any of the environments depicted in FIGS. 1-4 and 7, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various aspects, the method 500 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where a hyperparameter optimization (HPO) query is issued to a plurality of computing devices. In one embodiment, each of the plurality of computing devices may include an independent hardware computing device (e.g., a server, etc.). In another embodiment, each of the plurality of computing devices may include a node within a distributed computing system.

Additionally, in one embodiment, each of the plurality of computing devices may be logically and physically separate from the other computing devices. In another embodiment, each of the plurality of computing devices may have its own private data set (e.g., training data). For example, the private data set of a computing device may only be assessed by that computing device, and other computing devices within the plurality of computing devices may not have access to the data set of another computing device.

Further, in one embodiment, each of the plurality of computing devices may include a party within a federated learning environment. For example, the federated learning environment may include an aggregator in communication with each of the plurality of computing devices. In another example, the HPO query may be sent by the aggregator to each of the plurality of computing devices. In yet another example, the aggregator may include a central node tasked with training a global model (e.g., a machine learning model such as a neural network, a decision tree, etc.). In still another example, each of the plurality of computing devices may have a corresponding local model separate from the global model.

Further still, in one embodiment, the HPO query may include a request to perform a plurality of HPO operations at each of the plurality of computing devices, and a performance metric to be optimized. For example, each of the plurality of computing devices may perform the plurality of HPO operations in parallel, separately from the other computing devices. In another example, the performance metric of the HPO query may include one or more of predictive machine learning metrics including absolute or relative accuracy or loss and resource metrics including runtime and memory utilization.

Also, method 500 may proceed with operation 504, where HPO results are received from each of the plurality of computing devices. In one embodiment, the HPO results may include the results of running a plurality of HPO operations on each of the plurality of computing devices. In another embodiment, the HPO results may include a set of hyperparameter (HP)/performance metric pairs. For example, the performance metric may include any user-specified predictive performance metric, such as loss, accuracy, F1, balanced accuracy, etc. In yet another embodiment, hyperparameters may include parameters used within a machine learning model during a training of the model.

In addition, in one embodiment, each of the plurality of computing devices, each HP/performance metric pair may include a hyperparameter and a corresponding loss value generated via the HPO operations utilizing that hyperparameter within a machine learning model of the computing device. In another embodiment, the HPO results may be received by an aggregator from each of the plurality of computing devices.

Furthermore, method 500 may proceed with operation 506, where a unified performance metric surface is generated utilizing the HPO results from each of the plurality of computing devices. In one embodiment, a union of the HPO results from each of the plurality of computing devices may be created. For example, the union may combine all of the received HPO results (e.g. HP/performance metric pairs from all of the computing devices) into a single set of HP/performance metric pairs.

Further still, in one embodiment, the unified performance metric surface may include a trained machine learning model. In another embodiment, the unified performance metric surface may be trained utilizing the unioned/combined set of HP/performance metric value pairs. For example, the features of the machine learning model may include the hyperparameters, and the performance metric values may include the targets of the regression model. In another example, the machine learning model may be trained by mapping hyperparameters to single scalar values. In another embodiment, the aggregator may perform the union of the HPO results, and may generate the unified performance metric surface.

Also, method 500 may proceed with operation 508, where optimal global hyperparameters are determined utilizing the unified performance metric surface. In one embodiment, for each hyperparameter value in the union of the HPO results, a prediction may be determined utilizing the trained unified performance metric surface to determine a loss value for that hyperparameter. In another embodiment, hyperparameters that produce an optimal performance metric (e.g., a lowest loss when compared to other hyperparameters, a loss below a predetermined threshold, etc.) may be selected as optimal global hyperparameters.

Additionally, in one embodiment, the aggregator may determine the optimal global hyperparameters. In another embodiment, the optimal global hyperparameters may be sent to each of the plurality of computing devices. For example, each of the plurality of computing devices may determine a local loss surface utilizing their local HPO results. In another example, each of the plurality of computing devices may determine optimal local hyperparameters utilizing the local loss surface and the optimal global hyperparameters.

Further, in one embodiment, the optimal global hyperparameters may be used to determine a global model structure and/or train the global model. For example, the optimal global hyperparameters may be applied to a global model, and the global model may be trained utilizing federated learning. In another example, an aggregator managing the training of a global model may be in communication with a plurality of computing devices (e.g., parties). In another embodiment, the aggregator may train a global model, while each of the plurality of computing devices may train a local model separate from the global model. In yet another embodiment, the aggregator may apply the optimal global hyperparameters to the global model.

Further still, in one embodiment, the aggregator may send queries to each of the parties. For example, the queries may request local information from each of the parties. In another example, for a neural network implementation, the queries may request gradients that are evaluated on a local data set with current model weights for local models, etc. In yet another example, for a decision tree implementation, the queries may request a number of points that satisfy a certain condition (e.g., a value range, a predetermined label value, etc.). In another embodiment, the aggregator may receive replies from the parties in response to the queries, may aggregate the replies, may generate results based on the aggregation, and may update the global model, based on the results.

In this way, optimal hyperparameters may be dynamically determined for the global model. This may reduce an amount of processing necessary to fine-tune the global model during federated learning, which may improve a performance of computing hardware performing the federated learning (e.g., the aggregator, etc.).

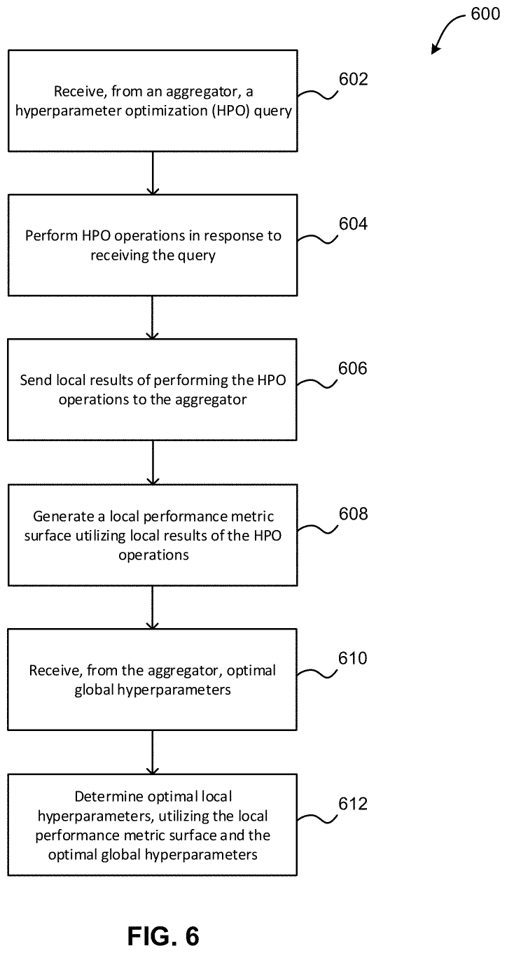

Now referring to FIG. 6, a flowchart of a method 600 is shown according to one embodiment. The method 600 may be performed in accordance with the present invention in any of the environments depicted in FIGS. 1-4 and 7, among others, in various embodiments. Of course, more or less operations than those specifically described in FIG. 5 may be included in method 600, as would be understood by one of skill in the art upon reading the present descriptions.

Each of the steps of the method 600 may be performed by any suitable component of the operating environment. For example, in various aspects, the method 600 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 may initiate with operation 602, where a hyperparameter optimization (HPO) query is received from an aggregator. In one embodiment, the HPO query may be received at an independent hardware computing device (e.g., a server, etc.). In another embodiment, the computing device may include a node within a distributed computing system. In yet another embodiment, the computing device may include a party within a federated learning environment. In still another embodiment, the HPO query may include a request to perform a plurality of HPO operations at the computing device.

Additionally, method 600 may proceed with operation 604, where HPO operations are performed in response to receiving the query. In one embodiment, performing the HPO operations may include generating different values for different hyperparameters at the computing device. In another embodiment, performing the HPO operations may include training a local model at the computing device, utilizing a local training data set and the generated hyperparameter values.

For example, the computing device may include one of a plurality of separate computing devices within a federated learning environment. In another example, the computing device may have its own local training data set that is not accessible by other computing devices within the federated learning environment.

Further, in one embodiment, performing the HPO operations may include evaluating, at the computing device, the trained local model on local test data to compute a loss value for each of the generated hyperparameter values. In another embodiment, the results of performing the HPO operations may include a plurality of local hyperparameter (HP)/performance metric pairs. For example, each HP/performance metric pair may indicate a hyperparameter used within the local model, and a corresponding loss value generated by the local model with that hyperparameter.

Further still, method 600 may proceed with operation 606, where local results of performing the HPO operations are sent to the aggregator. In one embodiment, the computing device may send the computed local HP/performance metric pairs to the aggregator that sent the HPO query.

Also, method 600 may proceed with operation 608, where a local performance metric surface is generated utilizing local results of the HPO operations. In one embodiment, the local performance metric surface may include a trained machine learning regression model. In another embodiment, the local performance metric surface may be trained utilizing the computed HP/performance metric pairs. For example, the features of the regression model may include the hyperparameters, and the performance metric values may include the targets of the regression model. In another example, the regression model may be trained by mapping hyperparameters to single scalar values. In another embodiment, the computing device may generate the local performance metric surface.

In addition, method 600 may proceed with operation 610, where optimal global hyperparameters are received from the aggregator. In one embodiment, the optimal global hyperparameters may be generated by the aggregator utilizing a unified performance metric surface and the HPO results from each of a plurality of computing devices.

Furthermore, method 600 may proceed with operation 612, where optimal local hyperparameters are determined utilizing the local performance metric surface and the optimal global hyperparameters. In one embodiment, for each hyperparameter value in the local HP/performance metric pairs, a prediction may be determined utilizing the trained local performance metric surface to determine a loss value for that hyperparameter. In another embodiment, hyperparameters that produce a minimum loss (e.g., a lowest loss when compared to other hyperparameters, a loss below a predetermined threshold, etc.) may be selected as optimal local hyperparameters.

Further still, in one embodiment, the optimal local hyperparameters and the optimal global hyperparameters may be applied to the local model, and the local model may be trained as part of the federated learning process.

In this way, optimal hyperparameters may be dynamically determined for the local model. This may reduce an amount of processing necessary to fine-tune the local model during federated learning, which may improve a performance of computing hardware performing the federated learning (e.g., the hardware computing device, etc.).

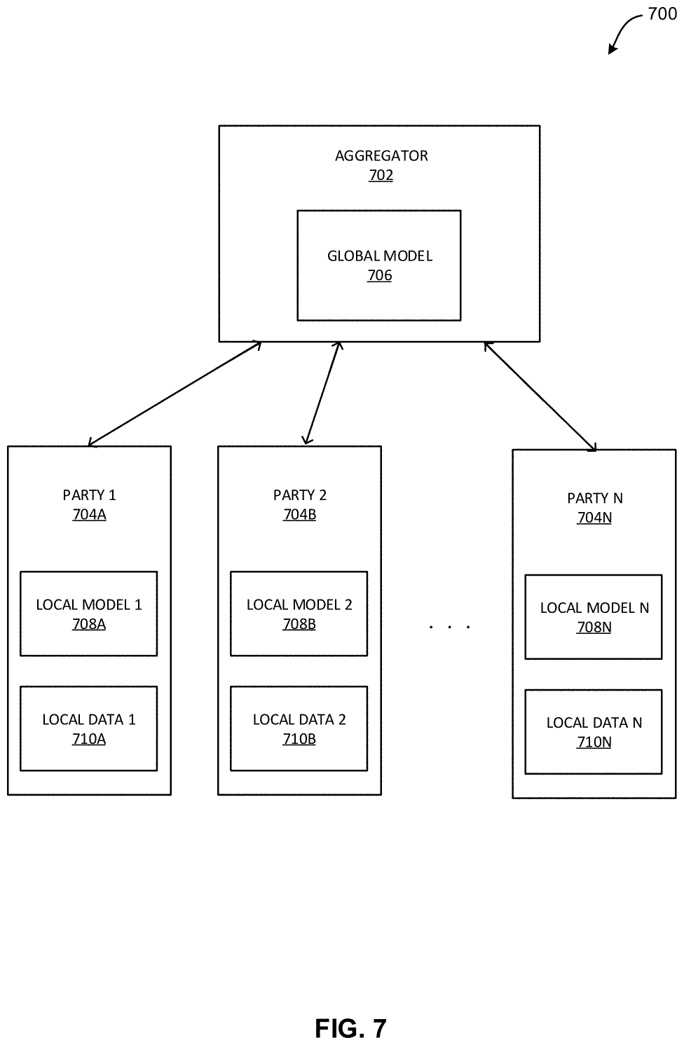

FIG. 7 illustrates an exemplary federated learning environment 700, according to one exemplary embodiment. As shown, the federated learning environment 700 includes an aggregator 702 in communication with a plurality of parties 704A-N. The aggregator 702 manages a global model 706, while each of the parties 704A-N manages a corresponding local model 708A-N. Each of the parties 704A-N has its own set of local data, which is not accessible by any of the other parties 704A-N or the aggregator 702.

In one embodiment, the aggregator 702 may issue a hyperparameter optimization (HPO) query to each of the plurality of parties 704A-N. In response to receiving the HPO query, each of the parties 704A-N may perform HPO operations. For example, each of the parties 704A-N may determine a plurality of local hyperparameter (HP)/loss pairs. In another embodiment, each of the parties 704A-N may perform the HPO operations separately from the other parties 704A-N. In yet another embodiment, the parties 704A-N may perform the HPO operations in parallel.

Additionally, in one embodiment, each of the parties 704A-N may send the results of the HPO operations (e.g., the local hyperparameter (HP)/loss pairs) to the aggregator 702. The aggregator 702 may create a union of the results, and may generate a unified loss surface utilizing the union. The aggregator 702 may then determine optimal global hyperparameters utilizing the unified loss surface, and may send the optimal global hyperparameters to each of the parties 704A-N.

Further, in one embodiment, before, during, or after the determination of optimal global hyperparameters by the aggregator 702, each of the parties 704A-N may generate, in parallel with each other, a local loss surface utilizing local results of the HPO operations. After receiving the optimal global hyperparameters from the aggregator 702, each of the parties 704A-N may determine optimal local hyperparameters, utilizing their local loss surface and the optimal global hyperparameters.

Further still, in one embodiment, each of the parties 704A-N may apply their optimal local hyperparameters and optimal global hyperparameters to their corresponding local model 708A-N. In another embodiment, the aggregator 702 may apply the optimal global hyperparameters to its global model 706. After optimal hyperparameters have been applied, the aggregator 702 may initiate federated learning.

For example, the aggregator 702 may send queries to each of the parties 704A-N requesting local information from each of the parties. The parties 704A-N may each generate a reply utilizing their corresponding local data 710A-N, and may send the reply to the aggregator 702. The aggregator 702 may receive and aggregate the replies, and may generate results based on the aggregation, where the results are used to update the global model 706.

In this way, optimal hyperparameters may be dynamically determined for the global model 706 and each of the local models 708A-N. This may minimize an amount of tuning that is performed for the global model 706 and each of the local models 708A-N, utilizing a single round of communication between the global model 706 and each of the local models 708A-N (instead of multiple rounds of communication in previous manual methods). This may reduce an amount of computing and communications bandwidth used by both the global model 706 and each of the local models 708A-N during the hyperparameter tuning process, which may improve a performance of the global model 706 and each of the local models 708A-N (each of which may be implemented in computing hardware).

### A Method to Auto-Tune Hyperparameters in Federated Learning Systems

Federated learning includes the collaborative training of a machine learning model without sharing/revealing training data. A federated learning environment includes an aggregator who monitors the federated learning process. The aggregator issues queries to parties, collects responses from the parties, and aggregates collected responses to update a global model.

Exemplary queries issued by the aggregator to learn the global predictive model include queries for gradients as well as parameters, given a current weight (model parameter). Additional queries may ask for information about a specific label (class), such as counts. Additionally, parties within the federated learning environment include participants who respond to the queries based on their local databases.

The selection of hyperparameters is very important in a federated learning system, especially where there might be data distribution heterogeneity among parties. In response, a systematic approach is provided to perform hyperparameter tuning in a federated learning system which ensures the performance of the final global model without compromising local data privacy among the parties under both IID and non-IID settings. In this disclosure we do not optimize hyperparameters related to aggregation/fusion step, for example, party selection strategy and/or party reply quorum, etc.

In one embodiment, a method to perform hyperparameter tuning in federated learning settings may include querying, by an aggregator, parties to perform hyperparameter optimization (HPO). Additionally, parties receiving the HPO query use their local dataset and the current model to run HPO to generate a set of features/loss pairs, and the set is sent to the aggregator.

Further, the aggregator uses the collected features/loss pairs to select the best global hyperparameters for FL training, and shares these best global hyperparameters with all parties. The parties use the features/loss pairs to select the best local hyperparameters for local training with the received best global hyperparameters. The aggregator orchestrates the FL training with the selected hyperparameters.

Further still, the aggregator may generate a unified loss surface using the union of all global hyperparameter/loss pairs collected from all the parties, and may select the best global hyperparameters via minimizing the unified loss surface function. Also, each party generates a per-party loss surface using the respected local hyperparameter/loss pairs and the selected global hyperparameters, and selects the minimizer of the per-party loss surfaces as the final local hyperparameters.

In addition, the loss surface is generated by training a machine learning model with the hyperparameters as the inputs and the corresponding loss as the targets. Furthermore, the HPO algorithms may include a random search algorithm, a Bayesian algorithm, etc.

### Single-Shot Hyper-Parameter Optimization for Federated Learning

Traditional machine learning (ML) approaches require training data to be gathered at a central location where the learning algorithm runs. In real world scenarios, however, training data is often subject to privacy or regulatory constraints restricting the way data can be shared, used and transmitted.

Federated learning (FL) has recently become a popular approach to address privacy concerns by allowing collaborative training of ML models among multiple parties where each party can keep its data private.

Despite the privacy protection FL brings along, there are many open problems in the FL domain, one of which is hyper-parameter optimization for FL. Existing FL systems require a user (or all participating parties) to pre-set (agree on) multiple hyper-parameters (HPs) (i) for the model being trained (such as number of layers and batch size for neural networks or tree depth and number of trees in tree ensembles), and (ii) for the aggregator (if such hyper-parameters exist).

Hyper-parameter optimization (HPO) for FL is important because the choice of HPs can have dramatic impact on performance. This is particularly important for tabular data (where datasets can be radically different from each other) as well as image data and neural nets. While HPO has been widely studied in the centralized ML setting, it comes with unique challenges in the FL setting. First, existing HPO techniques for centralized training often make use of the entire data set, which is not available in FL. Secondly, they train a vast variety of models for a large number of HP configurations which would be prohibitively expensive in terms of communication and training time in FL settings. Thirdly, one important challenge that has not been adequately explored in FL literature is support for tabular data, which are widely used in enterprise settings. One of the best models for this setting are based on gradient boosting tree algorithms which are not based on the stochastic gradient descent training algorithm used for neural networks.

In the centralized ML setting, we would consider a model class M and its corresponding learning Algorithm A parameterized collectively with HPs θ∈Θ, and given a training set D, we can learn a single model [symbol] ( [symbol] , θ, D)→m ∈ [symbol] . Given some predictive loss [symbol] (m, D′) of any model m scored on some holdout set D′, the centralized HPO problem can be stated as:

$${min}_{θ ∈ Θ} ℒ ( 𝒜 ( ℳ , θ , D ) , {D}^{′} ) \qquad ( 1 )$$

In the most general FL setting, p parties P₁, . . . Pₚ may exist, each with their private local training data set Dᵢ, i ∈ [p]. Let D=∪ᵢ₌₁^{p}Dᵢ denote the aggregated training data set and D̅={Dᵢ}_{i ∈[p]} the set of per-party data sets. Each model class (and corresponding learning algorithm) is parameterized by global HPs θ_{G} ∈ Θ_{G} shared by all parties and per-party local HPs θ_{L}⁽ⁱ⁾ ∈ Θ L, i ∈ [p] with Θ=ΘG×Θ_{L}. FL systems usually include an aggregator with its own set of HPs ϕ∈ Φ.

Finally, an FL algorithm [symbol] ( [symbol] , ϕ, θ_{G}, {θ_{L}⁽ⁱ⁾}i ∈ [p], [symbol] , D̅)→m E [symbol] may take as input all the relevant HPs and per-party data sets and generates a model. In this case, the FL-HPO problem can be stated in the two following ways depending on the desired goals: (i) For a global holdout data set D′ (a.k.a. validation set, possibly from the same distribution as the aggregated data set D), the following problem is solved:

$${min}_{ϕ ∈ Φ , {θ}_{G} ∈ {Θ}_{G} , {θ}_{L}^{( i )} ∈ {Θ}_{L} , i ∈ [ p ]} ℒ ( ℱ ( ℳ , ϕ , {θ}_{G} , {\{ {θ}_{L}^{( i )} \}}_{i ∈ [ p ]} , 𝒜 , \overline{D} ) , {D}^{′} ) \qquad ( 2 )$$

(ii) An alternative problem would involve per-party holdout data sets D′ᵢ, i ∈ [p] and the following problem is solved:

$${min}_{ϕ ∈ Φ , {θ}_{G} ∈ {Θ}_{G} , {θ}_{L}^{( i )} ∈ {Θ}_{L} , i ∈ [ p ]} Agg ( \{ ℒ ( ℱ ( ℳ , ϕ , {θ}_{G} , {\{ {θ}_{L}^{( i )} \}}_{i ∈ [ p ]} , 𝒜 , \overline{D} ) , {D}_{i}^{′} ) , i ∈ [ p ] \} ) , \qquad ( 3 )$$

where Agg: [symbol] ^{p}→ [symbol] is some aggregation function (such as average or maximum) that scalarizes the p per-party predictive losses.

Contrasting problem (1) to problems (2) & (3), the FL-HPO is significantly more complicated than the centralized HPO problem. As a result, problem (2) becomes the focus, although the single-shot FL-HPO scheme can be applied and evaluated for problem (3).

In one embodiment, the FL-HPO problem may be simplified in the following ways: (i) an assumption is made that there is no personalization so there are no per-party local HPs θ_{L}⁽ⁱ⁾, i ∈ [p], and (ii) a focus is made on the model class HPs θ_{G}. Hence the problem is updated as for a fixed aggregator HP ϕ:

$${min}_{{θ}_{G} ∈ {Θ}_{G}} ℒ ( ℱ ( ℳ , ϕ , {θ}_{G} , 𝒜 , \overline{D} ) , {D}^{′} ) \qquad ( 4 )$$

This problem appears similar to the centralized HPO problem (1). However, note that the main challenge in (4) is the need for a federated training for each set of HPs θ_{G}, and hence it is not practical (from a communication overhead perspective) to apply existing off-the-shelf HPO schemes to problem (4). In the subsequent discussion, for simplicity purposes, θ will be used to denote the global HPs, dropping the “G” subscript.

Leveraging Local HPOs

An exemplary algorithm for performing single-shot FL-HPO with federated loss surface aggregation is shown below:

```
FLoRA (Θ, [symbol]   , [symbol]   , {(Dᵢ, D′ᵢ)}_{i∈[p]}, T) → m
  for each party Pᵢ, i ∈ [p]do
    Run HPO to generate T (HP, loss) pairs
  E⁽ⁱ⁾ = {(θₜ⁽ⁱ⁾, [symbol]   ₜ⁽ⁱ⁾), t ∈ [T], θₜ⁽ⁱ⁾ ∈ Θ, [symbol]   ₜ⁽ⁱ⁾ := [symbol]   ( [symbol]   ( [symbol]   , θₜ⁽ⁱ⁾, Dᵢ), D′ᵢ)}(5)
  end
  Collect all E⁽ⁱ⁾, i ∈ [p] in aggregator
  Generate a unified loss surface [symbol]   : Θ → [symbol]   using {E⁽ⁱ⁾, i ∈ [p]}
  Select best HP candidate θ* ← arg min_{θ∈Θ} [symbol]    (θ)
  Learn final model with federated training: m ← [symbol]   ( [symbol]   , ϕ, θ*, [symbol]   , D̅)
  return m
  end
```

In the above scheme, each party is allowed to perform HPO locally and asynchronously with an adaptive HPO scheme such as BO. Then, at each party i ∈ [p] all the attempted T HPs θₜ⁽ⁱ⁾, t ∈ [T] and their corresponding predictive loss [symbol] ₜ⁽ⁱ⁾ are collected into a set E⁽ⁱ⁾ (line 3, equation (5)). Then these per-party sets of (HP, loss) pairs E⁽ⁱ⁾ are collected at the aggregator. This operation has at most O(pT) communication overhead (note that the number of HPs are usually much smaller than the number of columns or number of rows in the per-party data sets). These sets are then used to generate an aggregated loss surface [symbol] :Φ→ [symbol] which will then be used to make the final single-shot HP recommendation θ*∈ Φ for the federated training to create the final model m ∈ [symbol] .

The reason to use adaptive HPO schemes instead of non-adaptive schemes such as random search or grid search is that this allows us to efficiently approximate the local loss surface more accurately (and with more certainty) in regions of the HP space where the local performance is favorable instead of trying to approximate the loss surface well over the complete HP space. This has advantages both in terms of computational efficiency and loss surface approximation.

Each party executes HPO asynchronously, without coordination with HPO results from other parties or with the aggregator. This is in line with our objective to minimize communication overhead. Although there could be strategies that involve coordination between parties, they could involve many rounds of communication.

Loss Surface Aggregation

Given the sets E(i), i ∈ [p] of (HP, loss) pairs (θₜ⁽ⁱ⁾, [symbol] ₜ⁽ⁱ⁾), i ∈ [p], t ∈ [T] at the aggregator, a loss surface [symbol] :Φ→ [symbol] may be constructed that best emulates the (relative) performance loss [symbol] (θ) that would be observed when training the model on D̅.

In one embodiment, the loss surfaces may be modeled using regressors that try to map any HP to their corresponding loss. These loss surfaces may be constructed in the following ways:

Single Global Model (SGM)

All the sets E(i), i ∈ [p] are merged into E and used as a training set for a regressor f: Φ→ [symbol] which considers the HPs θ ∈ Φ as the covariates and the corresponding loss as the dependent variable. For example, we can a random forest regressor may be trained on this training set E. Then the loss surface can be defined as [symbol] (θ):=f(θ). This loss surface may end up recommending HPs that have low loss in just one of the parties.

Single Global Model with Uncertainty (SGM+U)

Given the merged set E of the per-party sets of (HP, loss) pairs, a regressor may be trained that provides uncertainty quantification around its predictions (such as Gaussian Process Regressor) as f:Φ→ [symbol] , u: Φ→ [symbol] +, where f (θ) is the mean prediction of the model at θ ∈ Φ while u(θ) quantifies the uncertainty around this prediction f(θ). The loss surface may be defined as [symbol] (θ): =f (θ)+α·u(θ) for some scalar α>θ. This loss surface may prefer HPs that have a low loss even in just one of the parties, but it penalizes a HP if the model estimates high uncertainty around this HP.

Maximum of Per-Party Local Models (MPLM)

Instead of a single global model on the merged set E, a regressor f⁽ⁱ⁾:Φ→ [symbol] , i ∈ [p] may be trained with each of the per-party set E⁽ⁱ⁾, i ∈ [p] of (HP, loss) pairs. Given this, the loss surface may be constructed as

$$ℓ ( θ ) := {max}_{i ∈ [ p ]} {f}^{( i )} ( θ ) .$$

This can be seen as a much more pessimistic loss surface, assigning a low loss to a HP only if it has a low loss estimate across all parties.

Average of Per-Party Local Models (APLM)

A less pessimistic version of MPLM would be to construct the loss surface as the average of the per-party regressors f⁽ⁱ⁾, i ∈ [p] instead of the maximum, defined as [symbol] (θ):=1/p Σᵢ₌₁^{p}f⁽ⁱ⁾(θ). This is also less optimistic than SGM since it will assign a low loss for a HP only if its average across all per-party regressors is low, which implies that all parties observed a relatively low loss around this HP.

In one embodiment, a method to auto-tune hyperparameters in a federated learning system includes issuing by the computing device a hyperparameter optimization function to one or more participants in a federated learning scheme; receiving from the one or more participants in the federated learning scheme one or more features and one or more loss pairs based upon data local to each participant; selecting by the computing device one or more hyperparameters for federated learning training based upon the received one or more features and one or more loss pairs; and orchestrating by the computing device a federated learning training based upon the selected one or more hyperparameters.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to aspects of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various aspects may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that aspects of the present invention may be provided in the form of a service deployed on behalf of a customer to offer service on demand.

The descriptions of the various aspects of the present invention have been presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein.

What is claimed is:

1. A computer-implemented method, comprising:
issuing a hyperparameter optimization (HPO) query to a plurality of computing devices;
receiving HPO results from each of the plurality of computing devices;
generating a unified performance metric surface utilizing the HPO results from each of the plurality of computing devices; and
determining optimal global hyperparameters, utilizing the unified performance metric surface.

2. The computer-implemented method of claim 1, wherein each of the plurality of computing devices includes a party within a federated learning environment.

3. The computer-implemented method of claim 1, wherein the HPO query includes a request to perform a plurality of HPO operations at each of the plurality of computing devices and a performance metric to be optimized.

4. The computer-implemented method of claim 1, wherein the HPO results include a set of hyperparameter (HP)/performance metric value pairs.

5. The computer-implemented method of claim 1, comprising creating a union of the HPO results from each of the plurality of computing devices.

6. The computer-implemented method of claim 1, comprising training the unified performance metric surface utilizing a combined set of HP/performance metric value pairs.

7. The computer-implemented method of claim 1, comprising:
for each hyperparameter value in a union of the HPO results, determining a prediction utilizing the unified performance metric surface to determine a performance metric value for that hyperparameter; and
selecting hyperparameters that produce an optimal performance metric when compared to other hyperparameters as optimal global hyperparameters.

8. The computer-implemented method of claim 1, comprising sending the optimal global hyperparameters to each of the plurality of computing devices.

9. The computer-implemented method of claim 1, comprising utilizing the optimal global hyperparameters to determine a global model structure, train the global model, or determine the global model structure and train the global model.

10. The computer-implemented method of claim 9, comprising training the global model utilizing federated learning.

11. The computer-implemented method of claim 1, wherein the HPO query includes a request to perform a plurality of HPO operations at each of the plurality of computing devices and a performance metric to be optimized, where the performance metric of the HPO query is selected from the group consisting of:
predictive machine learning metrics including absolute or relative accuracy or loss, and
resource metrics including runtime and memory utilization.

12. A computer program product comprising one or more computer readable storage media, and program instructions collectively stored on the one or more computer readable storage media, the program instructions comprising instructions configured to cause one or more processors to perform a method comprising:
issuing, by the one or more processors, a hyperparameter optimization (HPO) query to a plurality of computing devices;
receiving, by the one or more processors, HPO results from each of the plurality of computing devices;
generating, by the one or more processors, a unified performance metric surface utilizing the HPO results from each of the plurality of computing devices; and
determining, by the one or more processors, optimal global hyperparameters, utilizing the unified performance metric surface.

13. The computer program product of claim 12, wherein each of the plurality of computing devices includes a party within a federated learning environment.

14. The computer program product of claim 12, wherein the HPO query includes a request to perform a plurality of HPO operations at each of the plurality of computing devices and a performance metric to be optimized.

15. The computer program product of claim 12, wherein the HPO results include a set of hyperparameter (HP)/performance metric value pairs.

16. The computer program product of claim 12, comprising creating, by the one or more processors, a union of the HPO results from each of the plurality of computing devices.

17. The computer program product of claim 12, comprising training, by the one or more processors, the unified performance metric surface utilizing a combined set of HP/performance metric value pairs.

18. The computer program product of claim 12, comprising:
for each hyperparameter value in a union of the HPO results, determining, by the one or more processors, a prediction utilizing the unified performance metric surface to determine a performance metric value for that hyperparameter; and
selecting, by the one or more processors, hyperparameters that produce a optimal performance metric when compared to other hyperparameters as optimal global hyperparameters.

19. The computer program product of claim 12, comprising sending, by the one or more processors, the optimal global hyperparameters to each of the plurality of computing devices.

20. A computer-implemented method, comprising:
receiving, from an aggregator, a hyperparameter optimization (HPO) query;
performing HPO operations in response to receiving the query;
sending local results of performing the HPO operations to the aggregator;
generating a local performance metric surface utilizing local results of the HPO operations;
receiving, from the aggregator, optimal global hyperparameters; and
determining optimal local hyperparameters, utilizing the local performance metric surface and the optimal global hyperparameters.
